(19) United States
(12) Patent Application Publication
(10) Pub. No.: US 2024/0403188 A1
(43) Pub. Date: Dec. 5, 2024

(54) COMPUTER SYSTEM AND METHOD FOR PROCESSING DEBUG MESSAGE OF COMPUTER SYSTEM

(71) Applicant: PEGATRON CORPORATION, Taipei City (TW)

(72) Inventors: DEE-LUN TSAI, Taipei City (TW); ZHAN-YU ZHANG, Taipei City (TW)

(21) Appl. No.: 18/653,310

(22) Filed: May 2, 2024

(30) Foreign Application Priority Data
Jun. 1, 2023 (TW) 112120586

(51) Int. Cl. G06F 11/36; G06F 11/32

(52) U.S. Cl. CPC G06F 11/362; G06F 11/327

(57) ABSTRACT

The present invention provides a computer system and a method for processing a debug message of a computer system. The method includes the following steps: performing, by a first timer, timing when a computer system starts up; determining whether a first-stage confirmation signal is received within a first specific time; stopping the first timer and enabling a second timer to perform timing if the first-stage confirmation signal is received; determining whether a second-stage confirmation signal is received within a second specific time; stopping the second timer if the second-stage confirmation signal is received; enabling an input pin of a general-purpose input/output (GPIO) device to be at a low level if the first-stage confirmation signal is not received within the first specific time or the second-stage confirmation signal is not received within the second specific time; and outputting a debug message based on the low level.

### TECHNICAL FIELD

The present invention relates to a computer system and a method for processing a debug message of a computer system, and in particular, to a computer system capable of automatically outputting a debug message and a method for processing a debug message of a computer system.

### BACKGROUND

Nowadays, technology is changing rapidly, and therefore new hardware or firmware of a computer system is also constantly developed. However, in the development stage of a computer system, a case may occur in which the computer system stalls at a certain stage before startup is completed. In the prior art, when the startup of the computer system fails, except a possible downtime, no message is outputted, and a faulty drive element or a specific condition cannot be listed in detail. Therefore, in the prior art, if the startup of the computer system fails, a system developer is generally asked to generate a new version of a basic input/output system (BIOS) having a debug mode in which a debug message can be outputted through a serial port of the system, and to burn the new version to a computer, and then a detailed message of the serial port is outputted from the serial port of the system or SOL (Serial-over-LAN) of a baseboard management controller (BMC). If the BIOS has had firmware to enable a debug mode, the system developer is needed to enter a menu of the BIOS and choose to enable the serial port to output a debug message, and then the debug message can be obtained. In addition, if the BIOS has had the firmware to enable the debug mode, the system developer is needed to enable the serial port of the BIOS to output a debug message through an intelligent platform management interface (IPMI) command, so that the debug message can be obtained.

Therefore, when the system developer encounters a problem of startup of the computer system, the system developer cannot collect detailed messages immediately, but needs to manually remake a new version of the BIOS or enable a serial port of the BIOS to output a debug message by manually entering a menu of the BIOS or inputting an IPMI instruction. It may take a lot of time and cost for system developers. In addition, it is also possible that the reason for the real crash cannot be found because of the above actions of remaking the BIOS. Therefore, it is necessary to invent a new computer system and a method for processing a debug message of a computer system, to alleviate the defect of the prior art.

### SUMMARY

A main object of the present invention is to provide a method for processing a debug message of a computer system, which has a feature of automatically outputting a debug message when the computer system fails to start.

Another main object of the present invention is to provide a computer system applicable to the above method.

To achieve the above objects, the method for processing a debug message of a computer system of the present invention is applied to the computer system. The computer system includes a general-purpose input/output (GPIO) device, a firmware control device, a basic input/output system (BIOS), a first timer, and a second timer. The method includes the following steps: performing, by a first timer, timing when a computer system starts up; determining, by using the firmware control device, whether a first-stage confirmation signal is received within a first specific time; stopping, by using the firmware control device, the first timer and enabling a second timer to perform timing if the first-stage confirmation signal is received; determining, by using the firmware control device, whether a second-stage confirmation signal is received within a second specific time; stopping the second timer by using the firmware control device if the second-stage confirmation signal is received; enabling an input pin of a GPIO device to be at a low level by using the firmware control device if the first-stage confirmation signal is not received within the first specific time or the second-stage confirmation signal is not received within the second specific time; and enabling the BIOS to output a debug message based on the low level.

The computer system of the present invention includes a GPIO device, a firmware control device, a BIOS, a first timer, and a second timer. The GPIO device includes an input pin and an output pin. The firmware control device is electrically connected to the output pin of the GPIO device. The BIOS is electrically connected to the input pin of the GPIO device and is configured to output a debug message. The first timer is electrically connected to the firmware control device and configured to set a first specific time. The second timer is electrically connected to the firmware control device and configured to set a second specific time. During startup of the computer system, the first timer performs timing. If the firmware control device detects that the first-stage confirmation signal is received within the first specific time, the first timer is stopped and the second timer performs timing. If the firmware control device detects that the first timer reaches the first specific time, the input pin of the GPIO device is controlled to be at a low level. If the second-stage confirmation signal is received within the second specific time, the firmware control device stops the second timer. If the firmware control device detects that the second timer reaches the second specific time, the input pin of the GPIO device is controlled to be at the low level. The BIOS outputs the debug message in response to the input pin being at the low level.

### BRIEF DESCRIPTION OF THE DRAWINGS

FIG. 1 is a schematic diagram of an architecture of a computer system according to the present invention.

FIG. 2 is a flowchart of steps of a method for processing a debug message of a computer system of the present invention.

### DETAILED DESCRIPTION

In order to allow reviewers to better understand the technical content of the present invention, specific preferred embodiments are described as follows.

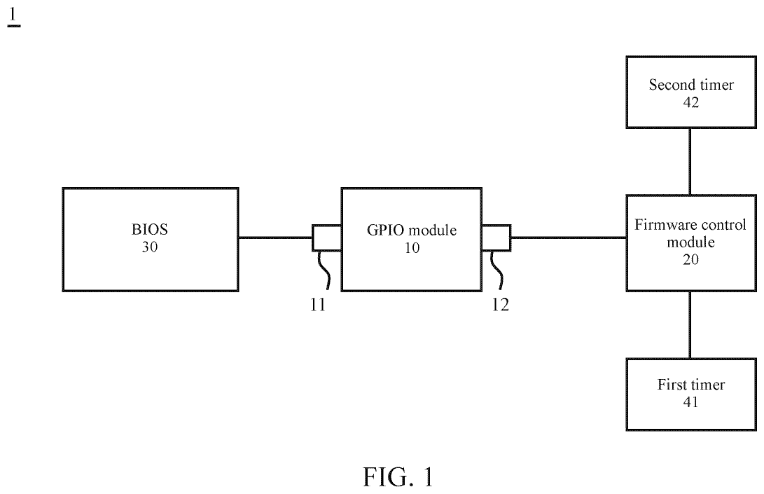

Refer to FIG. 1 first below. FIG. 1 is a schematic diagram of an architecture of a computer system according to the present invention.

The computer system 1 of the present invention is any system in a desktop computer, a servo computer or the like under development and design, such as, so that a system developer may readily learn a message that startup of the computer system 1 fails. The computer system 1 includes a general-purpose input/output (GPIO) device 10, a firmware control device 20, a basic input/output System (BIOS) 30, a first timer 41, and a second timer 42. The GPIO device 10 includes an input pin 11 and an output pin 12. The firmware control device 20 may be a baseboard management controller (BMC), a system input/output (SIO) chip, a complex programmable logic device (CPLD), or a field programmable gate array (FPGA), but the present invention is not limited thereto. The firmware control device 20 is electrically connected to the output pin 12 of the GPIO device 10, to execute a necessary procedure during startup of the computer system 1. The BIOS 30 is electrically connected to the input pin 11 of the GPIO device 10. The BIOS 30 is also a necessary program during startup of the computer system 1, and the BIOS 30 is not handed over for execution by software such as an operating system before finishing its tasks. Moreover, in an embodiment of the present invention, the BIOS 30 may record a debug message such as a time the computer system 1 fails to start up and a crashed block, and can output the recorded debug message.

The first timer 41 and the second timer 42 are electrically connected to the firmware control device 20. The first timer 41 is configured to set a first specific time as a timing function in a first stage during startup of the computer system 1. The first stage may be a stage after the startup of the computer system 1 begins and before the BIOS 30 begins performing its tasks, in which operations such as initialization of a chipset, initialization of a memory, and transfer of data are performed. The second timer 42 is configured to set a second specific time as a timing function in a second stage during startup of the computer system 1. The second stage may be a stage in which the BIOS 30 of the computer system 1 performs its tasks. The first timer 41 may be a fault resilient boot 3 (FRB-3) device, and the second timer 42 may be a fault resilient boot 2 (FRB-2) device. The first specific time may be 1 minute, and the second specific time may be 6 minutes. However, the present invention is not limited to this value. It should also be noted that the technology of using the FRB-3 device or the FRB-2 device to perform timing during startup of the computer system 1 to prevent a startup failure has been familiar to a person with ordinary knowledge in the technical field to which the present invention belongs. Therefore, the principle thereof is not described herein again.

In the stage after the startup of the computer system 1 begins and before the BIOS 30 begins performing its tasks, the firmware control device 20 controls the first timer 41 to perform timing. After the computer system 1 normally starts up and the BIOS 30 begins performing its tasks, the BIOS 30 outputs a first-stage confirmation signal. Therefore, if the firmware control device 20 receives the first-stage confirmation signal of the BIOS 30 through the output pin 12 of the GPIO device 10 within the first specific time, it may be confirmed that first-stage startup of the computer system 1 is completed. Therefore, the firmware control device 20 stops the first timer 41 and controls the second timer 42 to perform timing. However, if the firmware control device 20 detects that the first-stage confirmation signal has not been received when the first timer 41 reaches the first specific time, it may be confirmed that the computer system 1 failed to start up due to an error in a first-stage startup process. Therefore, the firmware control device 20 controls the input pin 11 of the GPIO device 10 to be at a low level. When the BIOS 30 learns that the input pin 11 is at the low level, the BIOS 30 automatically outputs the debug message to the system developer based on the low level. In addition, the firmware control device 20 also allows the computer system 1 to restart. The above debug message may be directly outputted through the GPIO device 10 or outputted through serial-over-LAN (SOL) of the firmware control device 20, and the present invention is not limited thereto.

In addition, if the startup operation of the BIOS 30 is executed, the BIOS 30 outputs a second-stage confirmation signal. Therefore, when the firmware control device 20 receives the second-stage confirmation signal from the BIOS 30 through the output pin 12 of the GPIO device 10 within the second specific time, the firmware control device 20 stops the second timer 42. In this case, it means that the startup processing process of the BIOS 30 has been successfully completed. If the firmware control device 20 detects that the second-stage confirmation signal from the BIOS 30 has not been received yet when the second timer 42 reaches the second specific time, it may be confirmed that the BIOS 30 failed to start up due to an error in a second-stage startup process. The firmware control device 20 controls the input pin 11 of the GPIO device 10 to be at the low level, so that the BIOS 30 outputs the debug message based on a state of the input pin 11, and the firmware control device 20 controls the computer system 1 to restart.

On the other hand, the system developer may also execute a command delivered by using an intelligent platform management interface (IPMI), and the firmware control device 20 controls the input pin 11 of the GPIO device 10 to be at the low level by executing the IPMI command. The BIOS 30 may output the debug message based on the state of the input pin 11.

It should be noted that devices of the computer system 1 may be composed of a hardware device, a combination of a software device and a hardware device, or the like, but the present invention is not limited thereto. In addition, this implementation only illustrates preferred embodiments of the present invention. To avoid redundancy, not all possible combinations are described in detail. However, it should be understood by a person skilled in the art that not all of the above devices or elements are necessary. In addition, to implement the present invention, other more detailed conventional devices or elements may also be included. Each device or element may be omitted or modified as required, and another device or element may not exist between any two devices.

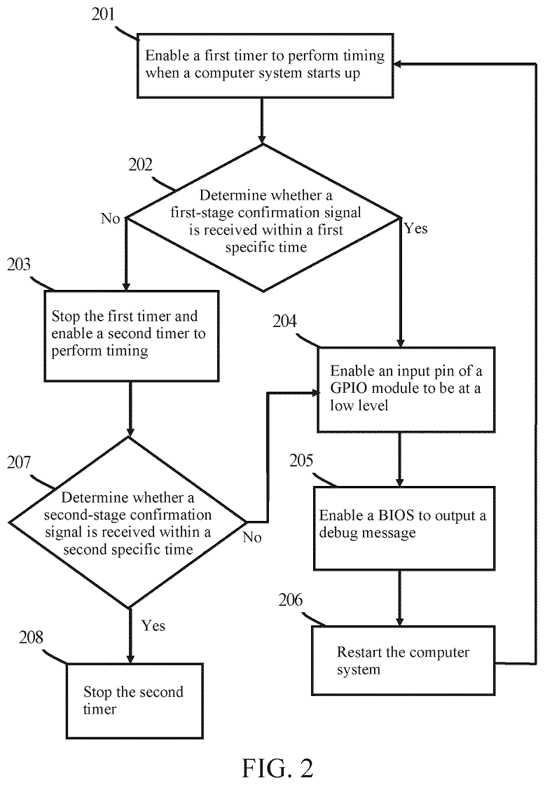

Then referring to FIG. 2, FIG. 2 is a flowchart of steps of a method for processing a debug message of a computer system of the present invention. It should be noted herein that although the above computer system 1 is used as an example to describe the method for processing a debug message of a computer system of the present invention, the method for processing a debug message of a computer system of the present invention is not limited to being applied to the computer system 1 with the same structure described above.

Step 201 of enabling the first timer to perform timing when the computer system starts up is first performed.

First, when the computer system 1 starts up in a first stage, a firmware control device 20 controls a first timer 41 to perform timing. A first specific time is set for the first timer 41.

Next, step 202 of determining whether a first-stage confirmation signal is received within the first specific time is performed.

Next, the firmware control device 20 determines whether a first-stage confirmation signal of a BIOS 30 has been received within the first specific time.

If the first-stage confirmation signal is received, it represents that first-stage startup of the computer system 1 has been completed. Then step 203 of stopping the first timer and enabling a second timer to perform timing is performed.

In this case, it may be confirmed that the first-stage startup of the computer system 1 is completed. Therefore, the firmware control device 20 stops the first timer 41, and controls the second timer 42 to perform timing. A second specific time is set for the second timer 42.

If the first-stage confirmation signal is not received within the first specific time in step 202, step 204 of enabling an input pin of a GPIO device to be at a low level is performed.

If the firmware control device 20 detects that the first-stage confirmation signal from the BIOS 30 has not been received when the first timer 41 reaches the first specific time, it may be confirmed that an error occurs in the computer system 1 in a first-stage startup process. Therefore, the firmware control device 20 controls the input pin 11 of the GPIO device 10 to be at the low level.

Then step 205 of enabling the BIOS to output a debug message is performed.

When the BIOS 30 learns that the input pin 11 is at the low level, the BIOS 30 automatically outputs the debug message to a system developer.

In addition, step 206 of restarting the computer system is performed.

In addition, the firmware control device 20 also allows the computer system 1 to restart, that is, step 201 is performed again.

Moreover, after step 203, the firmware control device 20 performs step 207 of determining whether a second-stage confirmation signal is received within the second specific time.

In this case, the firmware control device 20 determines whether a second-stage confirmation signal from the BIOS 30 has been received within the second specific time.

If the second-stage confirmation signal is received, step 208 of stopping the second timer is performed.

In this case, it represents second-stage startup of the computer system 1. In other words, the startup processing process of the BIOS 30 has been successfully completed and the second-stage confirmation signal is sent. Therefore, the firmware control device 20 stops the second timer 42 at this time.

If the firmware control device 20 does not receive the second-stage confirmation signal within the second specific time in step 207, it represents that an error occurs in the startup processing process of the BIOS 30. The firmware control device 20 performs step 204 of enabling the input pin of the GPIO device to be at the low level, step 205 of enabling the BIOS to output the debug message, and step 206 of restarting the computer system.

In addition, before step 204, the firmware control device 20 may also control the input pin 11 of the GPIO device 10 to be at the low level by using an IPMI command delivered by the system developer.

It should be noted herein that the method for processing a debug message of a computer system of the present invention is not limited to the step order described above, and the step order described above may be changed as long as the objects of the present invention can be achieved.

In this way, the computer system 1 of the present invention can automatically obtain debug data when the startup is unsuccessful, without the need for the system developer to deliver an additional command, which can effectively alleviate the defect of the prior art.

It should be noted that the above implementations only illustrate preferred embodiments of the present invention. To avoid redundancy, not all possible combinations are described in detail. However, it should be understood by a person skilled in the art that not all of the above devices or elements are necessary. In addition, to implement the present invention, other more detailed conventional devices or elements may also be included. Each device or element may be omitted or modified as required, and another device or element may not exist between any two devices. Any modification shall fall within the scope of the claims in this patent without deviating from the basic framework of the present invention, and should be subject to the scope of the patent application.

What is claimed is:

1. A method for processing a debug message of a computer system, applicable to a computer system, wherein the computer system comprises a general-purpose input/output (GPIO) device, a firmware control device, a basic input/output system (BIOS), a first timer, and a second timer, and the method comprises the following steps:
enabling the first timer to perform timing when the computer system starts up;
determining, by using the firmware control device, whether a first-stage confirmation signal is received within a first specific time;
stopping, by using the firmware control device, the first timer and enabling the second timer to perform timing if the first-stage confirmation signal is received;
determining, by using the firmware control device, whether a second-stage confirmation signal is received within a second specific time;
stopping, by using the firmware control device, the second timer if the second-stage confirmation signal is received;
enabling an input pin of the GPIO device to be at a low level by using the firmware control device if the first-stage confirmation signal is not received within the first specific time or the second-stage confirmation signal is not received within the second specific time; and
enabling the BIOS to output a debug message based on the low level.

2. The method for processing the debug message of the computer system according to claim 1, further comprising the following step:
controlling the computer system to restart by using the firmware control device if the first timer reaches the first specific time or the second timer reaches the second specific time.

3. The method for processing the debug message of the computer system according to claim 1, further comprising the following step:
continuously executing a startup procedure if the first-stage confirmation signal is received within the first specific time or the second-stage confirmation signal is received within the second specific time.

4. The method for processing the debug message of the computer system according to claim 1, further comprising the following step:
controlling the input pin of the GPIO device to be at the low level by executing an intelligent platform management interface (IPMI) command.

5. The method for processing the debug message of the computer system according to claim 1, further comprising the following step:
controlling the debug message to be outputted through the GPIO device or serial-over-LAN (SOL) of the firmware control device.

6. A computer system, comprising:
a GPIO device, comprising an input pin and an output pin;
a firmware control device, electrically connected to the output pin of the GPIO device;
a BIOS, electrically connected to the input pin of the GPIO device and configured to output a debug message;
a first timer, electrically connected to the firmware control device and configured to set a first specific time; and
a second timer, electrically connected to the firmware control device and configured to set a second specific time, wherein when the computer system starts up, the first timer performs timing; if the firmware control device detects that a first-stage confirmation signal is received within the first specific time, the first timer is stopped and the second timer performs timing; if the firmware control device detects that the first timer reaches the first specific time, the input pin of the GPIO device is controlled to be at a low level; if a second-stage confirmation signal is received within the second specific time, the firmware control device stops the second timer; and if the firmware control device detects that the second timer reaches the second specific time, the input pin of the GPIO device is controlled to be at the low level, and the BIOS outputs the debug message in response to the input pin being at the low level.

7. The computer system according to claim 6, wherein the firmware control device controls the computer system to restart if the first timer reaches the first specific time or the second timer reaches the second specific time.

8. The computer system according to claim 6, wherein a startup procedure is continuously executed if the firmware control device receives the first-stage confirmation signal within the first specific time or receives the second-stage confirmation signal within the second specific time.

9. The computer system according to claim 6, wherein the input pin of the GPIO device is further controlled to be at the low level by executing an IPMI command.

10. The computer system according to claim 6, wherein the debug message is outputted through the GPIO device or SOL of the firmware control device.

11. The computer system according to claim 6, wherein the firmware control device is a baseboard management controller (BMC), a system input/output chip (SIO), a complex programmable logic device (CPLD), or a field programmable gate array (FPGA).

12. The computer system according to claim 6, wherein the first timer is a fault resilient boot 3 (FRB-3) device, and the second timer is a fault resilient boot 2 (FRB-2) device.
